(19) United States
(12) Patent Application Publication
(10) Pub. No.: US 2009/0169062 A1
(43) Pub. Date: Jul. 2, 2009

(54) PERSONALS AD PROFILE SECRET PHOTO VERIFICATION PROCESS

(75) Inventors: Wai Yee Cheung, Hong Kong (HK); Jeff Ho Bun Yeung, Hong Kong (HK)

Correspondence Address: Yahoo! Inc.;c/o DARBY & DARBY P.C., P.O. BOX 770, Church Street Station, NEW YORK, NY, 10008-0770, US

(73) Assignee: Yahoo! Inc., Sunnyvale, CA (US)

(21) Appl. No.: 11/968,584

(22) Filed: Jan. 2, 2008

(51) Int. Cl. G06K 9/00; H04M 1/00

(52) U.S. Cl. 382/115; 455/550.1

(57) ABSTRACT

Managing verification of a submitted digital image of a person based on a comparison of another digital image of the person, where the person in the second image is illustrated in a specified pose, and/or is holding a specified object. The person provides the first digital image of themselves for use in participation in an online social networking experience, while the second digital image is not intended for display to others in the social network. The person is asked to provide the second digital image with the person in a defined pose, holding a particular object, wearing a particular article, or the like. The received digital images are then examined to determine whether they have been digitally modified, and to verify that the person within the two images is the same. If so, then the first image may be used in social networking activities by the person.

### TECHNICAL FIELD

The present invention relates generally to social networking and, more particularly, but not exclusively to verifying a person's first digital image based on a digital comparison of a submitted second digital image where the second image has the person in a specified pose, and/or holding a specified object.

### BACKGROUND

In today's world of computing, there are a large number of reasons why a person may elect to fake their identity when they communicate over the Internet. For example, people may wish to maintain anonymity when making purchases, visiting selected websites, playing a computer game, or performing other activities for which they would prefer not to use their actual identities.

There are many legitimate reasons for wanting to protect ones identity. For example, a person may desire to protect their identity because they do not wish to be harassed by others, or perhaps they have already been harassed, and wish to avoid it in the future. However, while many of these reasons are valid in some situations, they may be counterproductive in other situations. For example, they may be less than desirable in some social networking environments where participants actually would prefer to know with whom they are communicating. One such social networking environment involves online dating. In those situations, participants would prefer to know that the person that they seek to have an online dating experience with is who they claim to be. For example, it is preferable that when reviewing photographs of individuals in an online dating environment that the photograph is actually of that person and not of another person. Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of one embodiment of an environment in which the invention may be practiced;

FIG. 2 shows one embodiment of a mobile device that may be included in a system implementing the invention;

FIG. 3 shows one embodiment of a network device that may be included in a system implementing the invention;

FIG. 4 illustrates a logical flow diagram generally showing one embodiment of a process for managing verification of a digital image using a second digital image with a defined characteristic; and

FIG. 5 illustrates non-exhaustive examples of digital images generally showing one embodiment of having a person within an image in a defined pose useable to verify another image.

### DETAILED DESCRIPTION OF THE INVENTION

The present invention now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

As used herein, the terms “social network” and “social community” refer to a concept that an individual's personal network of friends, family colleagues, coworkers, and the subsequent connections within those networks. A social network, for example, can be utilized to find more relevant connections for a variety of activities, including, but not limited to dating, job networking, service referrals, content sharing, like-minded individuals, activity partners, or the like.

An online social network refers to a person's set of direct and/or indirect personal relationships, including real and virtual privileges and permissions that users may associate with these people. Direct personal relationships refers to relationships with people the user communicates with directly, including family members, friends, colleagues, coworkers, and other people with which the person has had some form of direct contact, such as contact in person, by telephone, by email, by instant message, by letter, or the like. These direct personal relationships are sometimes referred to as first-degree relationships. First-degree relationships can have varying degrees of closeness, trust, and other characteristics.

Indirect personal relationships refer to relationships through first-degree relationships to people with whom a person has not had some form of direct or limited direct contact, such as in being cc'd on an e-mail message, or the like. For example, a friend of a friend represents an indirect personal relationship. A more extended, indirect relationship might be a friend of a friend of a friend. These indirect relationships are sometimes characterized by a degree of separation between the people. For instance, a friend of a friend can be characterized as two degrees of separation or a second-degree relationship. Similarly, a friend of a friend of a friend can be characterized as three degrees of separation or a third-degree relationship, and so forth.

The following briefly describes the embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, embodiments are directed towards managing verification of a submitted digital image of a person based on a comparison of another digital image of the person, where the person in the second image is illustrated in a specified pose, and/or holding a specified object. Verification of the images is directed towards enhancing, among other things, the reliability of information within an online social networking experience.

An individual is requested as part of their participation to the online social networking experience to provide a digital image of themself. It is expected that the provided digital image is to be made available to other participants in the online social networking experience, such as an online dating experience, or other personals' services. In addition, the individual will be asked to provide a second digital image that includes the individual. It is intended that, in one embodiment, the second digital image is not provided to other participants. However, the individual will be asked to strike a defined pose, hold a particular object, wear a particular article, or the like, in the second digital image. For example, the individual might be asked to hold up a piece of paper or the like with a particular word, phrase, and/or symbol on it. In one embodiment, the object to be held might be sent to the individual over a network.

Similarly, the individual might be asked to provide the second digital image with the individual in a particular pose, such as winking, looking cross-eyed, laughing in an unusual manner, performing a specific gesture such as pointing 3 fingers downwards on the left hand, a combination of the above, and/or any of a variety of other possible actions, poses, gestures, or the like. In one embodiment, the pose may be selected based on being what may be referred to as a non-customary social gesture or pose. That is, it is selected from possible poses that might not typically be seen in such as family photographs, social photographs, portrait photographs, or the like. The pose is therefore selected to be sufficiently different from customary poses in such photographs that it is unlikely that the individual may already have a photograph of such a pose. Furthermore, the act or pose is directed towards being sufficiently unique that it might not be readily found in a pre-existing fake image, or a readily modified image. In one embodiment, the second digital image may be provided concurrent with the first digital image, or within a defined time period of sending the first digital image. The intent of defining a time period for the second digital image is directed towards discouraging faking of the second digital image.

The received digital images are then examined to determine whether they have been digitally modified. Such detection may be performed using any of a variety of detection mechanisms, including, but not limited to those performed at a pixel level. Moreover, the images may also be examined using any of a variety of facial recognition applications to verify that the person within the two images is the same. In another embodiment, the analysis of the digital images may be performed to detect if an age difference between the persons within the digital images is greater than a defined value. This age difference analysis is directed towards minimizing a likelihood that the digital images have been taken at significantly different times in the individual's life. For example, examination of the age difference is to detect if the individual is attempting to mislead others of the individual's current age.

In one embodiment, the digital images may be provided by the participant using any of a variety of mechanisms, including a digital camera within a mobile device, a distinct camera used to provide a photograph that may then be faxed, emailed, or the like.

If the digital images are verified at least as being of the same individual, in one embodiment, a social networking profile associated with the individual may be identified with an icon, symbol, or other identifier, indicating that the individual's images have been verified. Similarly, if the digital images are verified, in one embodiment, the individual may have the first digital image displayed at an associated social networking site for others to view.

### Illustrative Operating Environment

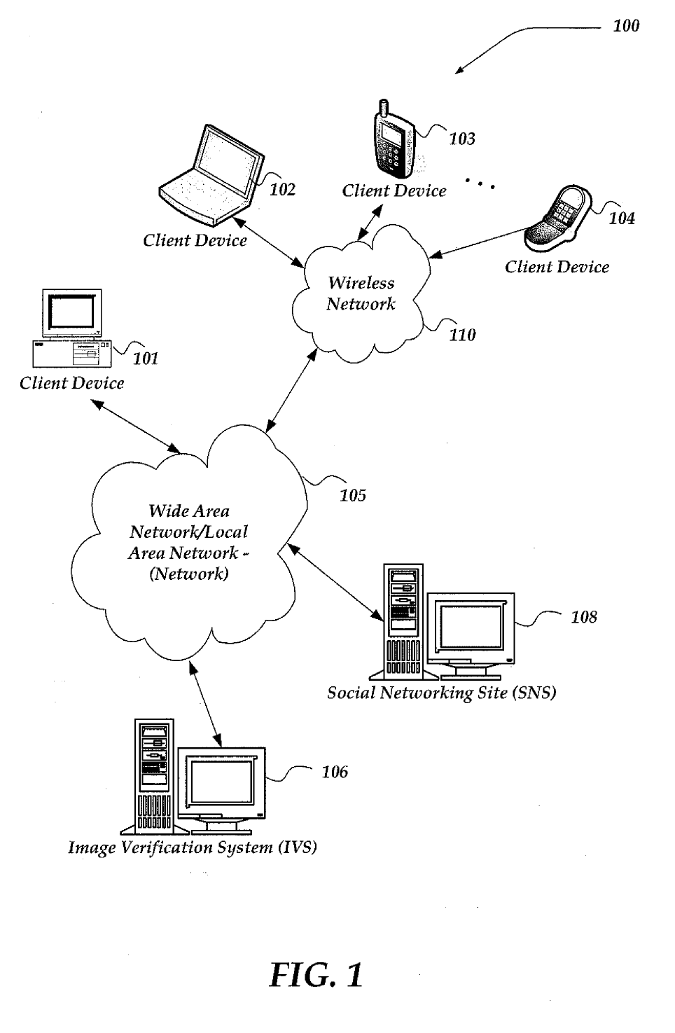

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)-(network) 105, wireless network 110, client devices 101-104, Image Verification System (IVS) 106, and Social Networking Site (SNS) 108.

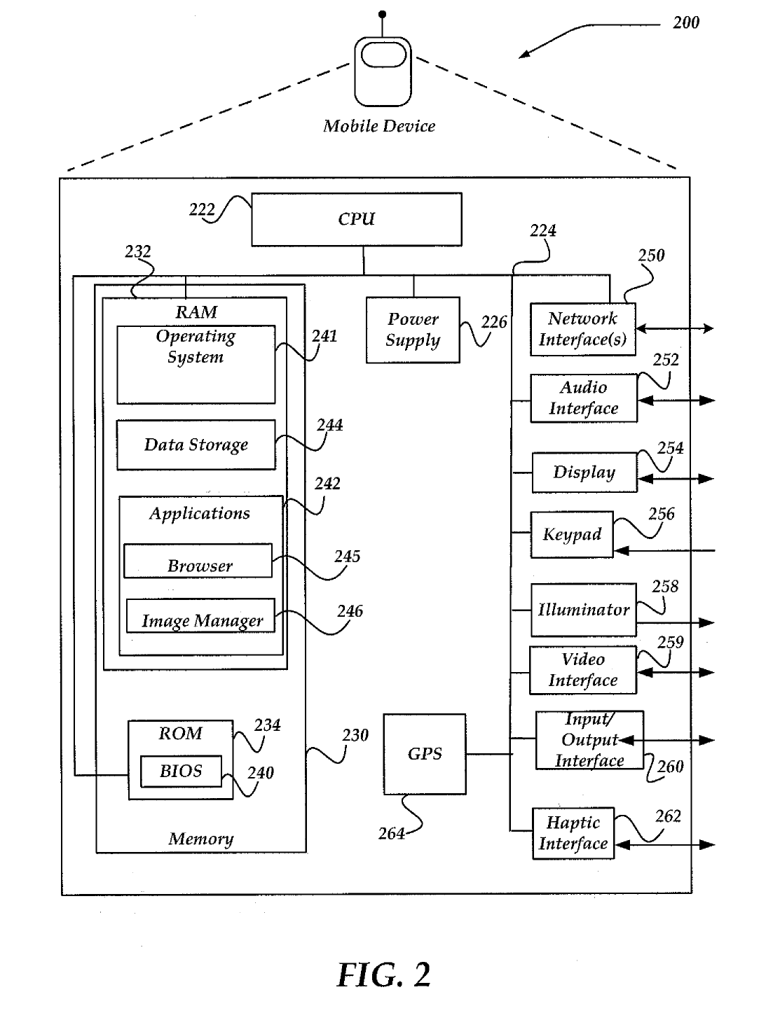

Generally, client devices 102-104 may include virtually any mobile computing device capable of receiving and sending a message over a network, such as wireless network 110, or the like. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, or the like. One embodiment of a mobile device usable as one of client devices 102-104 is described in more detail below in conjunction with FIG. 2.

Client device 101 may include virtually any computing device that typically connects using a wired communications medium such as personal computers, multiprocessor systems, microprocessor-based or programmable consumer electronics, network PCs, or the like. In one embodiment, at least one of client devices 101-104 may be configured to operate over a wired and/or a wireless network.

Client devices 101-104 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphics may be displayed.

A web-enabled client device may include a browser application that is configured to receive and to send web pages, web-based messages, or the like. The browser application may be configured to receive and display graphics, text, multimedia, or the like, employing virtually any web based language, including a wireless application protocol messages (WAP), or the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send a message.

Client devices 101-104 also may include at least one other client application that is configured to receive content from another computing device. The client application may include a capability to provide and receive textual content, multimedia information, or the like. The client application may further provide information that identifies itself, including a type, capability, name, or the like. In one embodiment, client devices 101-104 may uniquely identify themselves through any of a variety of mechanisms, including a phone number, Mobile Identification Number (MIN), an electronic serial number (ESN), network address, or other device identifier. The information may also indicate a content format that the client device is enabled to employ. Such information may be provided in a message, or the like, sent to another computing device.

Client devices 101-104 may also be configured to communicate a message, such as through email, Short Message Service (SMS), Multimedia Message Service (MMS), instant messaging (IM), internet relay chat (IRC), Mardam-Bey's IRC (mIRC), Jabber, or the like, between another computing device. However, the present invention is not limited to these message protocols, and virtually any other message protocol may be employed.

Client devices 101-104 may further be configured to include a client application that enables the user to log into a user account that may be managed by another computing device, such as SNS 108, IVS 106, or the like. Such user account, for example, may be configured to enable the user to receive emails, send/receive IM messages, SMS messages, access selected web pages, send and/or receive digital images, participate in a social networking activity, provide messages that may include links, attachments, or the like. However, managing of messages and/or other forms of communications may also be performed without logging into the user account.

Thus, a user of client devices 101-104 may employ any of a variety of applications to send and/or receive messages, read content, access content, or the like. In one embodiment, a user of client devices 101-104 may employ one or more applications to provide a digital image to, for example, a social networking site. In one embodiment, at least one of the digital images might then be shared with others.

In one example, the user might participate in an online social dating activity, a personals' service, or the like. In such social networking activities, it may be desirable for the user to provide a digital image of themself. Similarly, it may be desirable for the user to view digital images of others with whom the user may wish to communicate. In such examples, displaying/viewing digital images that accurately reflect the person associated with the social networking activity may be highly desirable. Thus, the user may be asked to submit a second digital image of the user that may be used verify the first digital image of the user. In one embodiment, the user of client devices 101-104 might submit the first digital image to SNS 108 for display within a social networking context, while the second digital image might be provided for use in verifying the first digital image. In one embodiment, the second digital image might include a picture of the user in a particular pose, holding a particular object, or the like. In one embodiment, the particular object/pose may be specified to the user through a communications from SNS 108, IVS 106, or the like. In one embodiment, the particular object might be sent to the user over the network.

In one embodiment, the user of client devices 101-104 might employ their client device to obtain at least one digital image. For example, the client device might be configured to include a camera or similar digital image capturing component, such as a digital scanner, or the like. In another embodiment, an image may be captured using a different device, and then provided to one of client devices 101-104 using any of a variety of mechanisms, including, but not limited to transmission over a network, such as wireless network 110 and/or network 105, or the like. For example, the user might employ a separate camera, take a photograph, and provide the photograph to client device 101-104 using a portable storage medium such as a compact disc, portable memory storage device, or the like. The user may even scan the photograph using a scanner that may be configured to provide a resulting digital image to the client device. In still another embodiment, the user may provide the digital image to the client device using email, MMS, or other messaging mechanism. Clearly, it should be understood that the user may provide to client device 101-104 the digital images using any of a variety of mechanisms, and therefore, the invention is not to be construed to be limited to merely those mentioned herein, and others are envisaged as well.

Wireless network 110 is configured to couple client devices 102-104 with network 105. Wireless network 110 may include any of a variety of wireless sub-networks that may further overlay stand-alone ad-hoc networks, or the like, to provide an infrastructure-oriented connection for client devices 102-104. Such sub-networks may include mesh networks, Wireless LAN (WLAN) networks, cellular networks, or the like.

Wireless network 110 may further include an autonomous system of terminals, gateways, routers, or the like connected by wireless radio links, or the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, or the like. Access technologies such as 2G, 3G, and future access networks may enable wide area coverage for client devices, such as client devices 102-104 with various degrees of mobility. For example, wireless network 110 may enable a radio connection through a radio network access such as Global System for Mobile communication (GSM), General Packet Radio Services (GPRS), Enhanced Data GSM Environment (EDGE), Wideband Code Division Multiple Access (WCDMA), Bluetooth, or the like. In essence, wireless network 110 may include virtually any wireless communication mechanism by which information may travel between client devices 102-104 and another computing device, network, or the like.

Network 105 is configured to couple IVS 106 and its components with other computing devices, including, SNS 108, client device 101, and through wireless network 110 to client devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between computing devices.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, or the like, in the signal. By way of example, communication media includes wired media such as twisted pair, coaxial cable, fiber optics, wave guides, and other wired media and wireless media such as acoustic, RF, infrared, and other wireless media.

SNS 108 includes virtually any network computing device that is configured to provide various online social networking content and/or services over network 105. As such, SNS 108 may operate to provide online dating services, personals' services, blogs, gossiping services, or the like. Moreover, the content and/or services may including messaging services, including, but not limited to email, text messaging, or the like. In addition, SNS 108 may provide access to a variety of content, including, but not limited to music, videos, photographs, search results, commentaries, news articles, educational articles, audio files, video files, text files, streaming files, graphical files, as well as advertisements, or the like. Thus, virtually any content may be available through SNS 108 for access by client devices 101-104. In one embodiment, SNS 108 might be configured and arranged to provide a website for users to post, view, link to, and/or otherwise access, content. SNS 108 might also provide FTP services, APIs, web services, database services, or the like, to enable users to access content. SNS 108 is not limited to merely these examples, and others are envisaged as well.

In one embodiment, a participant of the social networking site might register to become a member of the site. SNS 108 may include an interface that may request information from a participant of client devices 101-104. For example, SNS 108 may provide access to an account, which may request a participant's log-in information. However, in another embodiment, the participant might not need to log-in to access and/or provide information, content, and/or services from SNS 108.

In one embodiment, SNS 108 might provide a configuration where participants may be allowed to post information about themselves, such as might be provided in a blog, online dating service, or the like. In one embodiment, it may be desirable to verify, however, that the provided information is valid. For example, where a participant seeks to provide a digital image of themself, it may be desirable to verify that the digital image is of the participant. Thus, in one embodiment, SNS 108 may request a second digital image from the participant. In one embodiment, the digital image might not be made available to other participants, but may instead be used merely to verify the first digital image. In one embodiment, SNS 108 may provide the digital images to IVS 106 for verification. In one embodiment, IVS 106 may provide information indicating that the second digital image should have the participant in the image pose in a particular pose and/or hold a particular object. In one embodiment, IVS 106 might provide the object to be held.

In one embodiment, the participant might be redirected to IVS 106 to provide the digital images. In another embodiment, SNS 108 might provide an interface for interacting with the participant, and then provide the digital images, and/or other information to IVS 106 and/or the participant. In any event, IVS 106 may receive the digital images and perform a comparison of the digital images to determine if they have been digitally modified. Digital modification might include examination of the images to determine if, for example, one of the digital images was digitally modified to make it appear that the participant is in the particular pose and/or holding the particular object. The digital images may also be examined for other modifications that may indicate that the digital images may be fake. IVS 106 may also examine the digital images using a variety of mechanisms to determine whether the person within the images is likely to be the same person. IVS 106 may further examine the persons within the images to attempt to detect whether an age of the person in the first image is significantly different from an age of the person in the second image. If the age differences are determined to be greater than some defined value, then IVS 106 may invalidate the images. Such age differences may be relevant to further ensure that a person that might for example, be over a particular age does not submit a first digital image of themself when they were below another age. IVS 106 may further examine the second digital image to ensure that the person within the image is in the particular pose and/or holding the particular object.

IVS 106 may employ any of a variety of mechanisms to determine whether the person is in a particular pose and/or holding a particular object, including, but not limited to image recognition applications, including facial recognition programs, spatial recognition programs, scanning programs configured to search images for particular shapes, text, or the like. Further, IVS 106 may employ a variety of mechanisms to determine whether the age differences are greater than a particular value, including, but not limited to red-eye detector applications, such as described in U.S. Patent Application No. 20060045352 to Gallagher, entitled “Determining the age of a human subject in a digital image,” filed Sep. 1, 2004, which is incorporated herein by reference. However, the invention is not limited to this mechanism and others may be used. For example, age may also be determined using characteristics of facial features such as chins, sides of the face, eyes, nose, mouth, or the like, such as described in U.S. Pat. No. 5,781,650, to Lobo, et al., entitled “Automatic feature detection and age classification of human faces in digital images,” issued Jul. 14, 1998, which is also incorporated herein by reference. Other mechanisms may also be employed, without departing from the scope of the invention. Moreover, modification of the digital images may be performed using any of a variety of mechanisms, including examination at a by pixel level to detect changes in the image.

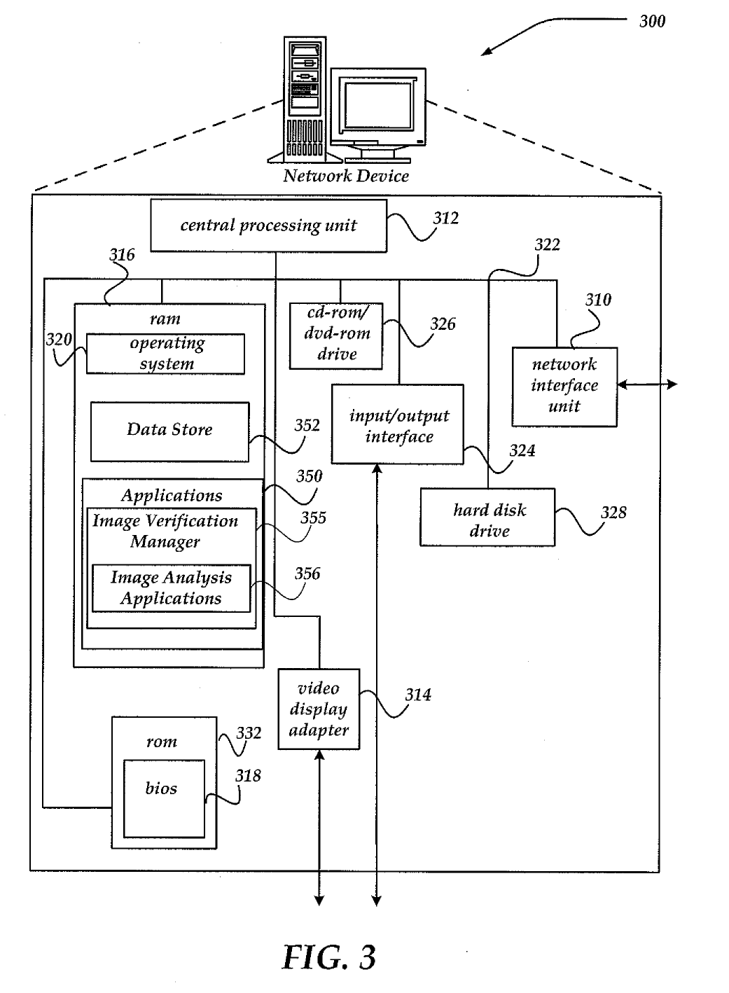

In any event, if IVS 106 determines that the images are valid based, in part, on the above mentioned examinations, IVS 106 may then enable the first image to be tagged, or otherwise marked as having been verified. In one embodiment, SNS 108 may further indicate within a profile associated with the participant that the image has been verified. In one embodiment, such verification indicator might be displayed for other participants to be informed that the image has been verified. In one embodiment, if the digital images are not verified, IVS 106 and/or SNS 108 may be configured to inhibit enabling display of the digital images at SNS 108. One embodiment of IVS 106 is described in more detail below in conjunction with FIG. 3.

Devices that may operate as IVS 106 and/or SNS 108 include, but are not limited to personal computers, desktop computers, multiprocessor systems, microprocessor-based or programmable consumer electronics, network PCs, servers, network appliances, and the like.

Moreover, although IVS 106 and SNS 108 are illustrated as separate and/or single network devices, the invention is not so limited. Thus, for example, SNS 108 may be configured and arranged to include IVS 106's functions and to perform its actions. In another embodiment, SNS 108 may be implemented as multiple network devices. Moreover, in another embodiment, IVS 106 may be implemented as multiple network devices.

### Illustrative Client Environment

FIG. 2 shows one embodiment of mobile device 200 that may be included in a system implementing the invention. Mobile device 200 may include many more or less components than those shown in FIG. 2. However, the components shown are sufficient to disclose an illustrative embodiment for practicing the present invention. Mobile device 200 may represent, for example, one of client devices 102-104 of FIG. 1.

As shown in the figure, mobile device 200 includes a processing unit (CPU) 222 in communication with a mass memory 230 via a bus 224. Mobile device 200 also includes a power supply 226, one or more network interfaces 250, an audio interface 252, video interface 259, a display 254, a keypad 256, an illuminator 258, an input/output interface 260, a haptic interface 262, and an optional global positioning systems (GPS) receiver 264. Power supply 226 provides power to mobile device 200. A rechargeable or non-rechargeable battery may be used to provide power. The power may also be provided by an external power source, such as an AC adapter or a powered docking cradle that supplements and/or recharges a battery.

Mobile device 200 may optionally communicate with a base station (not shown), or directly with another computing device. Network interface 250 includes circuitry for coupling mobile device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth™, infrared, Wi-Fi, Zigbee, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Video interface 259 is arranged to capture video images, such as a still photo, a video segment, an infrared video, or the like. For example, video interface 259 may be coupled to a digital video camera, a web-camera, or the like. Video interface 259 may comprise a lens, an image sensor, and other electronics. Image sensors may include a complementary metal-oxide-semiconductor (CMOS) integrated circuit, charge-coupled device (CCD), or any other integrated circuit for sensing light. In one embodiment, video interface 259 may employ image manager 246 to enable manage the capture and/or storage of digital images. In one embodiment, image manager 246 may store the digital images within data storage 244.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Mobile device 200 also comprises input/output interface 260 for communicating with external devices, such as a headset, or other input or output devices not shown in FIG. 2. Input/output interface 260 can utilize one or more communication technologies, such as USB, infrared, Bluetooth™, Wi-Fi, Zigbee, or the like. Haptic interface 262 is arranged to provide tactile feedback to a user of the client device. For example, the haptic interface may be employed to vibrate mobile device 200 in a particular way when another user of a computing device is calling.

Optional GPS transceiver 264 can determine the physical coordinates of mobile device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of mobile device 200 on the surface of the Earth. It is understood that under different conditions, GPS transceiver 264 can determine a physical location within millimeters for mobile device 200; and in other cases, the determined physical location may be less precise, such as within a meter or significantly greater distances. In one embodiment, however, a client device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of mobile device 200. The mass memory also stores an operating system 241 for controlling the operation of mobile device 200. It will be appreciated that this component may include a general purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Memory 230 further includes one or more data storage 244, which can be utilized by mobile device 200 to store, among other things, applications 242 and/or other data. For example, data storage 244 may also be employed to store information that describes various capabilities of mobile device 200. The information may then be provided to another device based on any of a variety of events, including being sent as part of a header during a communication, sent upon request, or the like. Moreover, data storage 244 may also be employed to store personal information including but not limited to address lists, contact lists, personal preferences, or the like. Data storage 244 may also include some profile information. At least a portion of the information may also be stored on a disk drive or other storage medium (not shown) within mobile device 200.

Applications 242 may include computer executable instructions which, when executed by mobile device 200, transmit, receive, and/or otherwise process messages (e.g., SMS, MMS, IM, email, and/or other messages), multimedia information, and enable telecommunication with another user of another client device. Other examples of application programs include calendars, browsers, email clients, IM applications, SMS applications, VOIP applications, contact managers, task managers, transcoders, database programs, word processing programs, security applications, spreadsheet programs, games, search programs, and so forth. Applications 242 may also include browser 245.

Browser 245 may include a browser application configured to receive and display graphics, text, multimedia, and the like, employing virtually any web based language. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web based languages may be employed.

Browser 245 may further be configured as a messenger application that is configured to send, to receive, and/or to otherwise process messages using SMS, MMS, IM, email, VOIP, and/or any of a variety of other messaging communication protocols. Although a single browser 245 is illustrated it should be clear that multiple applications may be employed. For example, one browser 245 may be configured to manage SMS messages, where another application may manage IM messages, and yet another messaging client is configured to manage emails, or the like, with one or more of such applications being able to manage messages using interest clusters and/or hop distances. One embodiment of an interface useable on mobile device 200 for managing messages is described in more detail below in conjunction with FIG. 6.

In one embodiment, browser 245 may be configured and arranged to provide digital images, perhaps stored in data storage 244, over a network to such as SNS 108 and/or IVS 106 of FIG. 1. In one embodiment, browser 245 may be used to further receive instructions such might have the user of mobile device 200 take a digital image of themselves, or another, in a particular pose, and/or holding a particular object. In one embodiment, the instructions might include the particular object to be held. For example, in one embodiment the user of mobile device 200 might receive a message that includes text, a symbol, or other content that when printed out, the user is to hold. In another embodiment, the message might instruct the user to generate the text, symbol, or other content and hold it in the second digital image. In one embodiment, if the digital images provided are verified, the user of mobile device 200 may then be enabled to display the first digital image at SNS 108. In one embodiment, if the digital images are not verified, the user might be provided another opportunity to provide another image, or might be inhibited from displaying the digital image at SNS 108.

### Illustrative Network Device Environment

FIG. 3 shows one embodiment of a network device, according to one embodiment of the invention. Network device 300 may include many more components than those shown. The components shown, however, are sufficient to disclose an illustrative embodiment for practicing the invention. Network device 300 may represent, for example, IVS 106 of FIG. 1.

Network device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 350 are loaded into mass memory and run on operating system 320. Examples of application programs may include transcoders, schedulers, calendars, database programs, word processing programs, HTTP programs, customizable user interface programs, IPSec applications, encryption programs, security programs, VPN programs, web servers, account management, and so forth. Applications 350 may include Image Verification Manager (IVM) 355, which may further include one or more image analysis applications 356.

IVM 355 is configured to receive a request for verification of a digital image. In one embodiment, IVM 355 may store the digital image in data store 352. In one embodiment, IVM 355 may then select instructions to be sent to the person within the digital image to provide a second digital image, wherein the person in the second digital image is in a particular pose and/or holding a particular object.

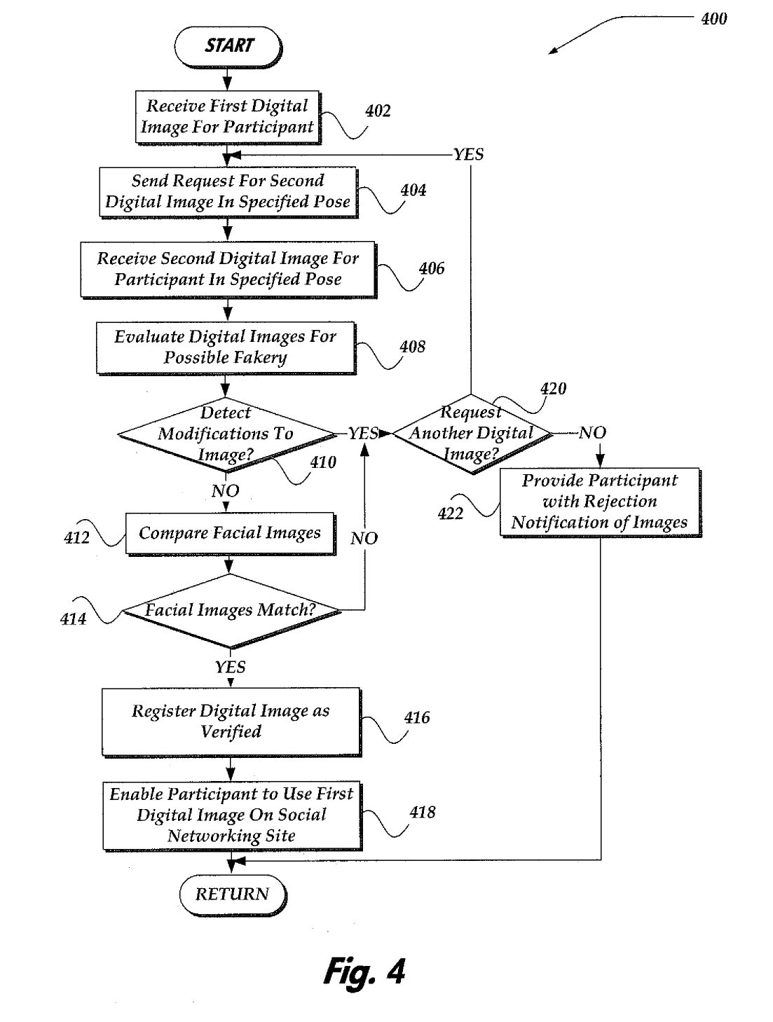

IVM 355 may then receive the second digital image and employ one or more image analysis applications 356 to examine the digital images to determine, in part, whether the person in the second digital image is in the particular pose and/or holding the particular object; whether the digital images have been modified; whether the persons within the first and second digital images are determined to be the same person; and/or whether an age difference between the persons in the first and second digital images is greater than a defined value. If IVM 355 determines that the images satisfy the defined criteria, then IVM 355 will enable the first digital image to be displayed at a defined social networking site. In one embodiment, IVM 355 might, even if the image fails at least one of the defined criteria, still allow the image to be displayed, but, the image (and/or a user profile associated with the image) might be marked or otherwise indicate that image is unverified, or failed its verification. IVM 355 might employ a process such as described below in conjunction with FIG. 4 to perform at least some of its actions.

Image analysis applications 356 may include any of variety of applications configured to enable IVM 355 to examine the provided digital images to determine whether to verify them. Thus, in one embodiment, at least one of the image analysis applications 356 might be configured to perform facial recognition to detect whether the persons within the digital images is likely to be the same. Image analysis applications 356 might also include applications configured to detect an age difference, using, for example, one of the mechanisms described above. Image analysis applications 356 may also include various applications configured to detect image modifications, using any of mechanisms described above. It should be clear however, the image analysis applications 356 are not limited to those described herein, and others may also be used. Moreover, other criteria, and thus, potentially, other image analysis applications may be included, without departing from the scope of the invention.

### Generalized Operation

The operation of certain aspects of the invention will now be described with respect to FIG. 4. FIG. 4 illustrates a logical flow diagram generally showing one embodiment of a process for managing verification of a digital image using a second digital image with a defined characteristic. Process 400 may be implemented, for example, within IVM 106 and/or SNS 108 of FIG. 1.

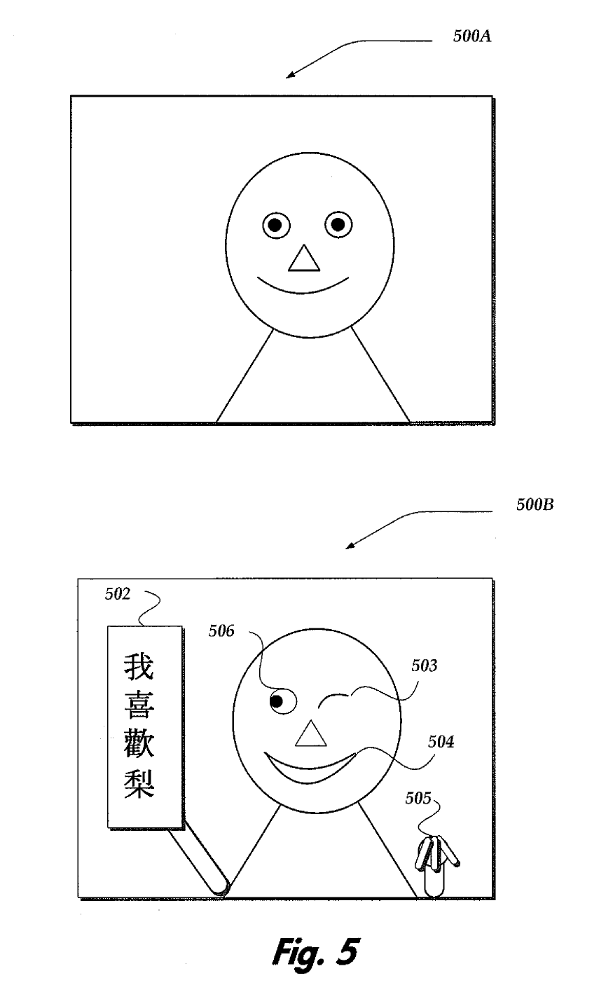

Process 400 begins, after a start block, at block 402, where a first digital image is received for a participant of a social networking site. In one embodiment, associated with the digital image may be a request that the first digital image is to be displayed at the social networking site for access by at least one other participant. For example, the participant may identify the digital image to be displayed at the social networking site for use in dating, personals, or the like. Thus, in one embodiment, the participant may be making a statement, implicit and/or explicit, that the person in the image is the participant. Briefly referring to FIG. 5, first digital image 500A might represent a simplified, non-exhaustive example of an image of the participant.

In any event, process 400 may then flow to block 404, where a request may be send to the participant for a second digital image, where the participant is to be in a particular pose and/or hold a particular object. In one embodiment, the request may include the particular object that the participant may then print out, or otherwise duplicate, locate, or the like.

Briefly referring to FIG. 5, second digital image 500B is directed towards representing a simplified, non-exhaustive example of the participant in a particular pose and holding a particular object 502. For example, as illustrated, the participant might be instructed to point their fingers 505 of their left hand downwards, have an open mouthed smile 504, and wink the left eye 503, while looking at the object with the right eye 506. Clearly, image 500B and such poses and/or objects are merely examples, and others may also be requested. Thus, these examples should not be construed as limited the invention in any manner.

Continuing with process 400, at block 406, the second digital image is received with the person within the image anticipated to be within the particular pose and/or holding the particular object. Processing moves next to block 408, where the first and/or second digital images are examined to determine if either of them has been modified. As stated above, any of a variety of mechanisms may be employed, including, but not limited to an examination at a pixel level, examining for inconsistent shading in an image, examination of rescaling of components within an image, examination of improper repetitions within the image, or the like. In another embodiment, modification to one or both images may be determined by making layered comparisons with threshold, layer modes, examining channel information, and or examining specialized separations, or the like. The invention, however, is not limited to these techniques, and others may readily be used. In any event, processing flows next to decision block 410, where a determination is made whether one or both of the images have been modified. If so, processing moves to decision block 420; otherwise, processing continues to block 412.

At block 412, virtually any image recognition application may be employed to compare the facial images to detect whether the persons with the images are likely to be the same person. Moreover, in one embodiment, various application, including those described above, may be employed to determine an age difference of the persons within the images.

Processing then flows to decision block 414, where a determination is made whether the images match, and in one embodiment, whether the age differences between the persons is less than (or equal to) a defined value. If the images are determined to not match and/or the age difference is greater than the defined value processing flows to decision block 420; otherwise, processing continues to block 416.

At block 416, the first digital image is identified as being verified. Such identification may be performed in any of a variety of ways. For example, in one embodiment, a mark, stamp, watermark, or the like, might be added to the digital image indicating that it has been verified. In another embodiment, a profile associated with the participant might include a file, record, or other verification indicator, that is configured to indicate that the digital image has been verified. For example, when the first digital image is posted or otherwise made available at a social networking site, the verification indicator might also be displayed indicating that the participant's digital image has been verified. In one embodiment, the verification indicator, might be configured such that it may include a date as to when the digital image was verified. The verification indicator might also expire automatically based on whether the first digital image is modified, deleted, replaced with another digital image, or the like.

In any event, processing moves next to block 418, where, in one embodiment, the verification indicator may enable the participant to post or otherwise provide access to the first digital image by others. Processing then returns to a calling process to perform other actions.

At decision block 420, however, a determination is made whether to request another digital image, based on rejection of the previously provided digital images (decision blocks 410 and/or 414). In this way, the participant may be allowed to provide, for example, another digital image to replace the first or second digital image, due for example, failure to detect the person to be in a proper pose, failure to detect the person holding the particular object, or other concerns. In any event, if another request is to be sent, processing flows back to block 404; otherwise, processing flows to block 422, wherein, in one embodiment, the participant may be notified that the digital images were rejected for failure to be able to verify them. Processing then returns to a calling process to perform other actions.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A network device to manage a digital submission over a network for use at a social networking site, comprising:
a transceiver to send and receive data over a network; and
a processor that is operative to perform actions, comprising:
receiving a first digital image that includes a person in the first digital image, the first digital image to be used for display to participants of the social networking site;
sending a request for a second digital image, instructing the person in the second digital image to be in a particular pose or to hold a particular object; and
performing an examination of the first and second digital images to verify that the second digital image includes the person in the particular pose or holding the particular object and to verify that the first and second digital images are of the same person, and if so, then enabling the person to display the first digital image at the social networking site.

2. The network device of claim 1, wherein performing the examination further comprises performing a by pixel analysis of at least the second digital image to determine if the second digital image has been digitally modified.

3. The network device of claim 2, wherein if the second digital image is determined to be digitally modified, selectively inhibiting the person to display either the first or the second digital image at the social networking site.

4. The network device of claim 1, wherein if the first and second digital images are verified, identifying with the display of the first digital image at the social networking site a symbol indicating that the person's digital image is verified.

5. A processor readable medium that includes data and instructions, wherein the execution of the instructions on a network device provides for managing a digital submission over a network useable in a social networking activity by enabling actions, comprising:
receiving a first digital image that includes a person in the first digital image;
sending a request for a second digital image that instructs the person to be in a particular pose or to hold a particular object in the second digital image; and
performing an examination of the first and second digital images to verify that the second digital image includes the person in the particular pose or holding the particular object and to verify that the first and second digital images are of the same person, and if so, then enabling the person to display the first digital image at the social networking site.

6. The processor readable medium of claim 5, wherein examining the first and second digital images to verify that they are of the same person further comprises employing a facial recognition mechanism.

7. The processor readable medium of claim 5, wherein the particular object is sent over the network to the person for use in the second digital image.

8. The processor readable medium of claim 5, wherein examination of the first and second digital images further comprises performing an analysis to determine if the first digital image and the second digital image are of the same person but at detectable different ages, wherein the detected age difference is above a defined value.

9. The processor readable medium of claim 5, wherein the particular pose is based on performing an atypical social gesture that is also not in the first digital image.

10. A method for managing a managing submission of a digital image over a network, comprising:
receiving a first digital image that includes a person in the first digital image;
sending a request for a second digital image that instructs the person to be in a particular pose or to hold a particular object in the second digital image; and
analyzing the first and second digital images to at least verify that the person within each digital image is the same person; and
if the person is the same, then annotating a profile associated with the person at a social networking site with information indicating that the first digital image is verified.

11. The method of claim 10, further comprising:
analyzing that the first and second digital images to determine if at least one of the digital images has been digitally modified, and if so inhibiting annotation of the profile.

12. The method of claim 10, further comprising:
confirming that the person in the second digital image is either in the particular pose or holding the particular object, and if not, then selectively inhibiting verification of the profile.

13. The method of claim 10, wherein the particular object includes an item having at least one specified word written on it.

14. A system for managing a submission of a digital image over a network, comprising:
a client device configured to send and to receive messages over the network, and to perform actions based on a user's input, the actions including:
sending a first digital image over a network, wherein the first digital image is to be used to modify a social networking profile associated with the user;
receiving a request for a second digital image instructing the user to be in a particular pose or holding a particular object; and
sending the second digital image over the network; and
a network device configured to send and to receive messages over the network and to perform actions, including:
receiving the first digital image;
associating the first digital image with the social networking profile of the user;
sending the request for the second digital image;
receiving the second digital image;
performing an analysis of the first digital image and the second digital image to verify at least that they include the same user in both digital images; and
based on a result of the analysis selectively identifying within the social networking profile for the user that the digital images are verified.

15. The system of claim 15, wherein performing an analysis further comprises:
verifying that neither the first digital image or the second digital image is digitally modified, and if either digital image is detected to be digitally modified, inhibiting identifying that the digital images are verified.

16. The system of claim 15, wherein verifying that the same user is in both digital images further comprises determining if a detectable age difference between the user in each digital image is greater than a determined value, and if so, requesting another digital image of the user.

17. The system of claim 15, wherein sending the request for the second digital image further comprises including the particular object and requesting that the included object be printed and held by the person in the second digital image.

18. A mobile device to manage digital image submissions over a network, comprising:
a transceiver to send and receive data over a network; and
a processor that is operative to perform actions, comprising:
sending a first digital image over a network;
receiving a request for a second digital image instructing the user to be in a particular pose or holding a particular object;
sending the second digital image over the network;
if the first digital image and the second digital image are determined at least to be of the same user and are undetected as being digitally modified, then receiving indication that the first digital image is verified; and
if the first digital image is verified, providing a request for the first digital image to be displayed at a social networking site.

19. The mobile device of claim 18, wherein determining at least that the digital images are of the same user further comprises employing a facial recognition.

20. The mobile device of claim 18, wherein the particular pose includes at least one of a facial expression, or a hand gesture, which is markedly different from a facial expression or hand gesture of the user in the first digital image and is directed towards being a non-customary facial expression or hand gesture.
